(19) United States
(12) Patent Application Publication
(10) Pub. No.: US 2012/0156538 A1
(43) Pub. Date: Jun. 21, 2012

(54) METHOD FOR PRODUCING A BATTERY ARRANGEMENT

(75) Inventors: Jens Meintschel, Bernsdorf (DE); Claus-Rupert Hohenthanner, Hanau (DE)

(73) Assignee: LI-TEC BATTERY GMBH, Kamenz (DE)

(21) Appl. No.: 13/379,948

(22) PCT Filed: Jun. 1, 2010
(86) PCT No.: PCT/EP2010/003318

§ 371 Date: Mar. 6, 2012

(30) Foreign Application Priority Data
Jun. 29, 2009 (DE) 10 2009 031 014.2

(51) Int. Cl. H01M 2/02; B32B 37/10; B32B 37/12; B32B 37/06; H01M 10/50; H01M 2/10

(52) U.S. Cl. 429/99; 429/163; 429/120; 429/151; 156/60

(57) ABSTRACT

The invention relates to a method for producing a battery arrangement (101, 201, . . . ), comprising at least one first electrochemical cell (102, 202,) and at least one second electrochemical cell (102, 202), wherein each electrochemical cell comprises a shell (103, 203), characterized in that a shell part (104, 105, 112; 204, 205, 212;) of the shell (103, 203,) of the first electrochemical cell (102, 202), is adhesively bonded to a shell part (104, 105, 112; 204, 205, 212;) of the shell (103, 203,) of the second electrochemical cell (102, 202).

The invention relates to a method for manufacturing a battery arrangement. The invention further relates to an electrochemical cell used for this purpose, as well as to a battery arrangement manufactured with the method.

Known from DE 603 14 076 T2 is a composite battery arrangement, which is formed by stacking and integrating a plurality of individual cells. The tongues of the individual cells represent the current conductor, and are connected with the tongue of an adjacent individual cell, for example via ultrasonic bonding. The plurality of composite electrochemical cells can be accommodated in a battery housing.

The object of the present invention is to provide an improved method for manufacturing a battery arrangement. This object is achieved by a method for manufacturing a battery arrangement, comprising at least one first electrochemical cell and at least one second electrochemical cell, wherein each electrochemical cell exhibits a shell, characterized in that a shell part of the shell of the first electrochemical cell is adhesively bonded with a shell part of the shell of the second electrochemical cell.

Within the meaning of the invention, an adhesive bond is to be understood as a bond between two components at an atomic or molecular level. Adhesively bonding the shells of the individual electrochemical cells together allows the electrochemical cells to establish a sold bond with each other, wherein there is no longer a need for another bonding device, in particular such as a housing or other bonding component. The adhesive bond can be designed based on the encountered circumstances, in particular the arising mechanical loads. The adhesive bond can preferably be created via heat sealing, heat pressing or bonding, in particular heat bonding.

Within the meaning of the invention, shell is understood as an at least partial margin that outwardly delineates one or more electrode stacks of an electrochemical cell. The shell is preferably gas and liquid tight, so that material cannot be exchanged with the environment. The electrode stacks are arranged inside the shell. At least one current conductor, in particular two current conductors, can extend out of the shell, and be used to connect the electrode stack. The outwardly extending current conductors here preferably represent the positive pole terminal and minus pole terminal of the electrochemical cell. However, several current conductors can also extend out of the shell, in particular an even number of current conductors. If the electrochemical cell here exhibits two electrode stacks connected in series, two electrodes of differing electrode stacks are preferably joined together. The shell can consist of one or more shell parts, in particular one or more molded parts and/or heat conducting plates. Further, a shell part can consist at least of one frame or frame part. One of the shell parts can here preferably exhibit a layer comprised of a sealable material, in particular a thermoplastic. The shell part is preferably fabricated out of a laminated packing film. The layer consisting of a sealable material is here preferably used to manufacture the adhesive bond. This is preferably to be understood as meaning that the adhesive bond is established exclusively by means of the layer consisting of a sealable material of a shell part or several shell parts. As a consequence, additional material need not be used for establishing the adhesive bond, which is not a constituent of the shell parts.

A laminated film, which can take the form of a laminated packing film, can be understood as a metallic carrier film or carrier sheet covered on at least one side with a sealable material, in particular a thermoplastic. The laminated films can be given a flat configuration, or designed as a molded part in a forming process, in particular through thermoforming. A molded part fabricated out of a laminated film is a laminated molded part. The metallic carrier film or metallic carrier sheet can preferably be made out of aluminum. In particular polypropylene and polyamide can be used as the thermoplastic.

In particular, a sealable material is understood as a material present in a solid state at room temperature, and preferably also at operating temperatures to be reached for the electrochemical cell. During the application of heat, which takes place in particular during manufacture with a sealing tool, the sealable material can at least partially assume a liquid or only semi-liquid state, and adhesively bond with other components. In particular, two quantities of sealable material separated from each other in a solid state can merge together in a semi-liquid or liquid state, thereby entering into an adhesive bond with each other.

Within the meaning of the invention, an electrode stack is to be understood as an arrangement which, as an assembly of a galvanic cell, also serves to store chemical energy and release electrical energy. Stored chemical energy is converted into electrical energy prior to the release of electrical energy. During the charging process, the electrical energy supplied to the electrode stack or galvanic cell is converted into chemical energy and stored. To this end, the electrode stack exhibits several layers, at least one anode layer, one cathode layer and a separator layer. The layers are laid or stacked one on top of the other, wherein the separator layer is arranged at least partially between an anode layer and a cathode layer. This sequence of layers preferably repeats itself several times over within the electrode stack. Several electrodes are preferably connected with each other, in particular electrically, especially connected in parallel. The layers are preferably wound into an electrode coil. In the following, the term “electrode stack” is also used for electrode coil.

Within the meaning of the present invention, a frame is to be understood as any structural arrangement that is particularly suitable for mechanically stabilizing the electrochemical cell against environmental influences, and can be rigidly joined with the packaging of the cell while manufacturing the cell. As already intimated by the wording selected, a frame is preferably an essentially frame-shaped arrangement, whose function essentially involves in particular imparting mechanical stability to an electrochemical cell. The frame can here be a shell part itself, in particular if the frame performs the described functions of the shell in an area of the shell. A partially circumferential frame can here be provided only on one or several sides of the electrochemical cell, and in particular encompass one or more frame strips. The partially circumferential frame does not necessarily completely envelop the electrode stack.

A molded part is here to be understood as a solid body, in particular one adjusted to the form of an electrode stack. A molded part preferably acquires its shape and/or stability only when interacting with another molded part and/or an electrode stack. In the case of a square electrode stack, the molded parts can be essentially cut into rectangles. The molded part here preferably exhibits a surface section that can essentially be adapted against a largest lateral surface of the square electrode stack, and has essentially a flat configuration, wherein a flat configuration permits a certain spatial deviation. Some selected dimensions of the molded part are here preferably larger than certain dimensions of an electrode stack. If two molded parts are placed around the electrode stack, the molded parts in part project over the electrode stack, partially forming an overhanging edge that constitutes a seam section. The seam section of a molded part here preferably touches a seam section of another molded part, preferably in a planar manner. For example, a first molded part of a shell is designed as a flat plate, while a second molded part of the shell is adapted against the first molded part around the electrode stack. A molded part can be designed as a heat conducting element, in particular as a heat conducting plate, and exhibit a higher thermal conductivity than the remaining molded parts. In particular, it partially contacts at least one electrode stack in a thermally conductive manner. Depending on a temperature difference between the molded part and an electrode stack, thermal energy is transferred from or into an electrode stack. A molded part is preferably arranged between two electrode stacks, and contacts both electrode stacks in a thermally conductive manner. The term molded part here also encompasses laminated molded parts in particular.

A bonding section of the first electrochemical cell is here preferably applied to a bonding section of the second electrochemical cell, wherein the bonding section is arranged on a shell part of the respective electrochemical cell.

In the following, a bonding section is to be understood as an area of the shell provided for adhesive bonding with another electrochemical cell. A bonding section can exhibit a certain planar configuration, specifically a bonding surface in particular, with which the bonding section can be made to abut the shell of the other electrochemical cell. In addition, however, the bonding section can be provided on nearly any part of the shell of an electrochemical cell without any special configuration.

The shell itself is here preferably formed by bonding a first shell part with at least one second shell part. In this respect, the shell in particular consists of several parts. Only by joining several shell parts together is the shell itself sealed.

A first shell part of the first electrochemical cell is preferably bonded with one of the shell parts of the second electrochemical cell during the manufacturing process, before the first shell part of the first electrochemical cell is bonded with a second shell part of the first electrochemical cell. As a result, shell parts of adjacent electrochemical cells can already be rigidly bonded together before the individual electrochemical cell is completed, and thereby subsequently form a component provided for further processing. Only after the aforementioned bonding of the two shell parts of different electrochemical cells is complete can the shells of the electrochemical cells be closed by bonding additional shell parts to aforesaid shell parts. Because several shell parts of different electrochemical cells are already rigidly bonded with each other before the electrochemical cells are closed, several electrochemical cells can be rigidly bonded with each other after the individual electrochemical cells have been closed. This makes it possible to simplify the manufacture of battery arrangements.

Only after a shell part of the first electrochemical cell has been bonded with a shell part of the second electrochemical cell is an electrode stack preferably made to abut a shell part of the first electrochemical cell. Subsequently, after the electrode stack has been made to abut the shell part of the first electrochemical cell, the first electrochemical cell can be closed by applying at least one additional shell part.

A shell part, in particular a molded part, can preferably be used as a shell part for at least partially enveloping two, in particular three adjacent electrochemical cells. Meant here in particular is that this shell part can represent both a shell part of the one electrochemical cell as well as a shell part of the other electrochemical cell. The number of parts can be reduced as a result, which can favorably impact costs and weight. The lower number of parts can also simplify assembly.

At least one of the shell parts is preferably a molded part. At least one of the shell parts is preferably a heat conducting plate. At least one of the shell parts is a frame or frame part. There are various ways of combining the different types of shell parts, specifically in particular molded part, heat conducting plate, frame or frame part.

The invention further relates to an electrochemical cell, comprising at least one electrode stack, which is enveloped at least partially by a shell, wherein the shell encompasses at least one molded part with a surface section and seam section, wherein the seam section is circumferentially arranged around the surface section, characterized in that a bonding section is provided. Reference is made to the above explanation with regard to the bonding section and the cited advantages.

One of the molded parts preferably exhibits a layer comprised of a sealable material, in particular a thermoplastic, and is made in particular out of a laminated packing film. The layer comprised of sealable material can preferably be used to manufacture an adhesive bond with another molded part. The molded part is preferably a laminated molded part.

The seam section preferably protrudes out of a plane E, in which the surface section is arranged. Seam section here denotes an area of the molded part provided for abutment against another shell part of the same electrochemical cell. In this regard, the seam section in particular represents a joint of the shell of an electrochemical cell. Parts of the seam section can here at least partially embody the bonding section. The bonding section can preferably adjoin at least a portion of the seam section.

In this case, at least two bonding sections are preferably provided, which in particular are arranged on opposing sides of the molded part, in particular on opposing areas of the circumferential seam section. Several bonding sections can also be provided. Providing at least two bonding sections imparts an elevated strength to the attachment of at least two electrochemical cells. The configuration of the bonding sections can here be adjusted to the arising loads.

At least one bonding section is preferably arranged on a side of the seam section facing away from the surface section. As a result, a bonding device preferably situated outside of the actual shell can be formed. Arising loads caused by the points at which the individual electrochemical cells are attached to each other here preferably do not affect the critical shell region near the electrode stack. In addition, the bonding sections are particularly readily accessible for a tool, which can be used to secure the individual bonding sections. In particular, the bonding sections are here situated remote from thermally critical locations of the shell in proximity to the electrode stack. This favors a good dissipation of heat from the electrode stacks via the shell, as well as the fatigue strength of the bond between two electrochemical cells.

At least one bonding section preferably protrudes from the seam section toward the plane E. The surface section preferably arranged in plane E can be an abutment surface for an adjacent electrochemical cell. Because the bonding section protrudes toward plane E, the bonding section can be made to abut the bonding section of an adjacent electrochemical cell, which also protrudes toward the surface section of the other electrochemical cell, so that a solid bond is possible between these two bonding sections, wherein the surface sections of the two electrochemical cells can at the same time be made to abut each other.

In an alternative configuration, at least one bonding section protrudes from the seam section, away from plane E. The surface section preferably situated in plane E can here be an abutment surface for an adjacent electrochemical cell. However, since the bonding section now protrudes over the seam section away from plane E, the bonding section is spaced further apart from plane E, and therefore projects over the seam section toward an electrochemical cell situated on the other side of the electrochemical cell in relation to plane E, so that the bonding section can be used for purposes of bonding with this electrochemical cell. In this regard, an inner surface of the molded part can be bonded both with another molded part of the same electrochemical cell, as well as with a molded part of a second electrochemical cell. This can further also yield an improved sealing effect. This is because, should a bond on the seam sections of two molded parts belonging to an electrochemical cell develop a leak, the bonding site between the two molded parts of adjacent electrochemical cells could assume the sealing functions, and prevent material from being exchanged between the environment and the cell interior.

The bonding section preferably encompasses a bonding surface, which is arranged in particular parallel to plane E, especially in plane E. The bonding surface is used to bond the bonding section with the bonding section of an adjacent electrochemical cell, wherein the adhesive bond is established on the bonding surfaces of the adjacent electrochemical cells. As a consequence, the parallel alignment of the bonding surfaces relative to plane E, and hence to the surface section of the molded part, allows the electrochemical cells to become aligned to each other parallel to plane E as well. If the bonding surface is situated in plane E, the surface sections of the adjacent electrochemical cells can abut each other.

The invention further relates to an electrochemical cell of the aforementioned kind, wherein two molded parts are bonded together at their seam sections, in particular adhesively bonded together. The at least two molded parts can be identical or mirror-inverted molded parts; slight deviations remain unaffected by the identical or mirror-inverted form, in particular those owing to installability or manufacture. However, they can also be various molded parts of the kind already described.

In a preferred embodiment, the shell can encompass at least one heat conducting plate, wherein at least one molded part with a seam section is flanged to the heat conducting plate. The heat conducting plate itself here represents a shell part, and at least sections thereof assume the functions of the shell.

The battery arrangements of the aforementioned kind can basically be easy to install.

The invention further relates to a battery arrangement comprising a first electrochemical cell and a second electrochemical cell, which are adhesively bonded with each other. Reference is made to the already described advantages of the adhesive bond. The shells of the respective electrochemical cells are preferably adhesively bonded with each other. In particular, the adhesive bond can be established by means of heat sealing, heat pressing or heat bonding.

At least one of the shell parts preferably exhibits a layer comprised of a sealable material, in particular of a thermoplastic, and is in particular made out of a laminated packing film. The adhesive bond between the shell parts is formed by at least portions of the layer comprised of sealable material of one or several of the respective shell parts. The adhesive bond is here preferably exclusively the layer comprised of a sealable material of one or several of the shell parts, and used to fabricate the adhesive bond. In particular, this means that the adhesive bond is established without the use of any additional aids that are not a constituent of the shell parts, e.g., adhesives or sealants.

A shell part can be designed as a molded part, in particular as a laminated molded part.

The first electrochemical cell preferably encompasses an at least partially circumferential first frame, in particular a completely circumferential first frame, and the second electrochemical cell encompasses an at least partially circumferential second frame, in particular a completely circumferential second frame, wherein the frames of adjacent chemical cells exhibit sections with different radial expansions. The term radial expansion is here generally not to be construed as meaning that the expansion is to be circular or resemble a circle. Rather, the term radial expansion basically refers to the expansion that essentially runs coaxial to a perpendicular on a flat shell section, in particular the surface section. In this regard, the radial expansion can also exhibit an angular configuration.

Because the first radial expansion is larger than the second radial expansion, at least one section of the one frame overlaps a section of the other frame. The entire frame can also overlap the respective other entire frame. The overlapping of at least sections of the first frame gives rise to sections lying radially outside the second frame, into which an installation tool can project so as to bond a shell part with the first frame. In particular, first electrochemical cells can alternate with second electrochemical cells, making it possible to simplify the installation of the first electrochemical cells on the second electrochemical cells or vice versa through the recesses formed by the respective second frame and first frame or respective sections thereof.

For this purpose, the first frame of the first electrochemical cell preferably exhibits a covering section, on which the first frame of the first electrochemical cell covers the second frame of the second electrochemical cell, and the first frame of the first electrochemical cell further exhibits an overlapping section on which the first frame overlaps the second frame.

The invention further encompasses a battery arrangement fabricated in the aforementioned manner.

The seam sections of adjacent electrochemical cells preferably form a honeycomb bonding structure with bonding sections of adjacent electrochemical cells. The honeycomb bonding structure between the individual molded parts can generate a robust bond against external loads while at the same time keeping the weight low.

The invention will be explained in greater detail below based on the figures. Shown on:

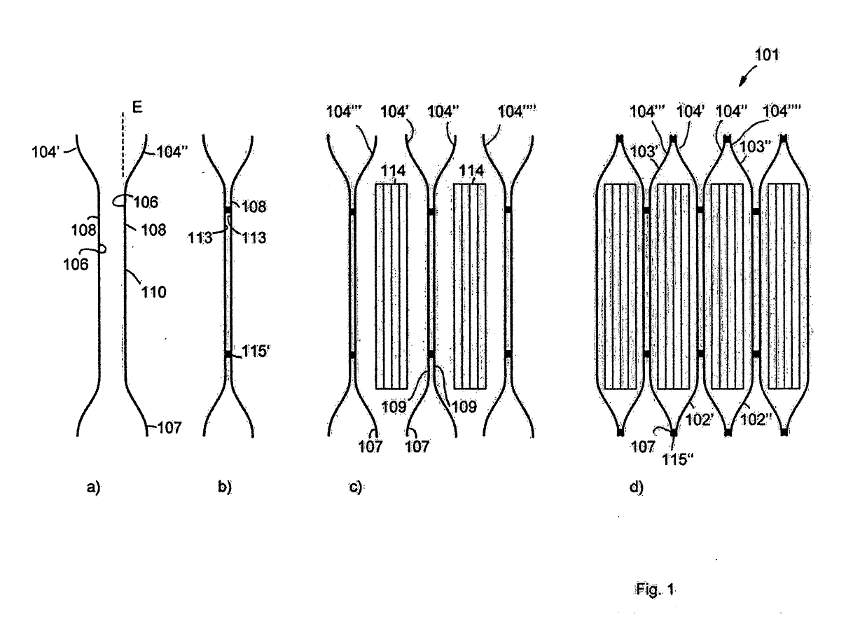

FIG. 1 is a diagrammatic cross section of a battery arrangement in a first embodiment during the individual manufacturing steps a) to d);

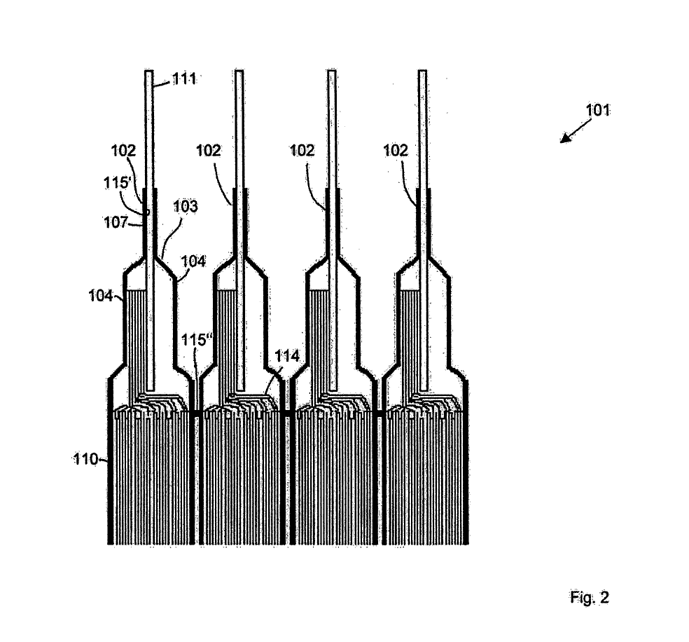

FIG. 2 is a partial cross section of the battery arrangement from FIG. 1;

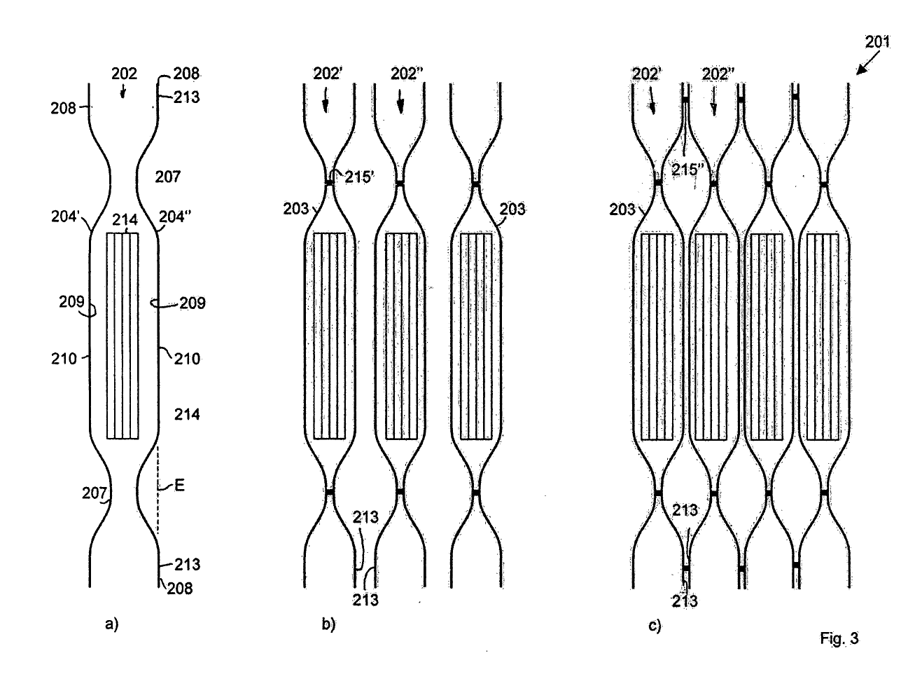

FIG. 3 is a diagrammatic cross section of a battery arrangement in a second embodiment during the individual manufacturing steps a) to c);

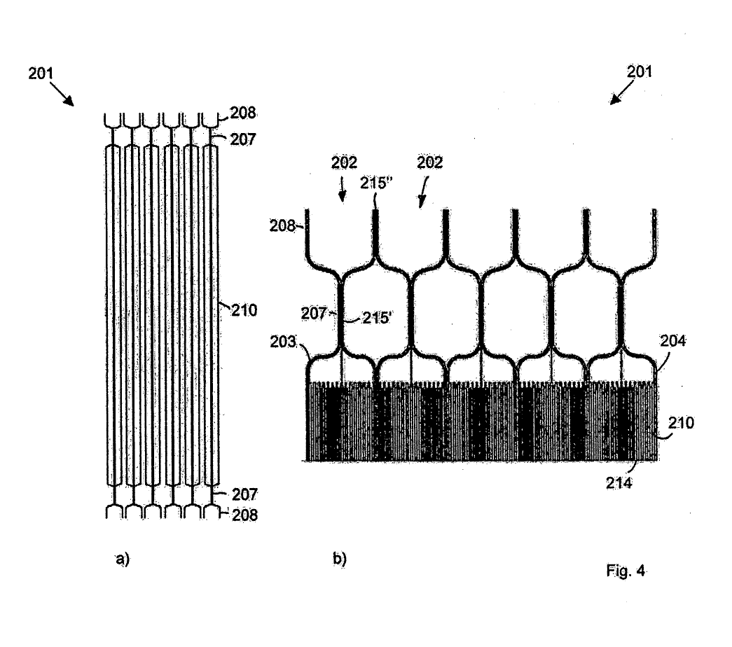

FIG. 4 is the battery arrangement from FIG. 3
a) from below,
b) in partial cross section;

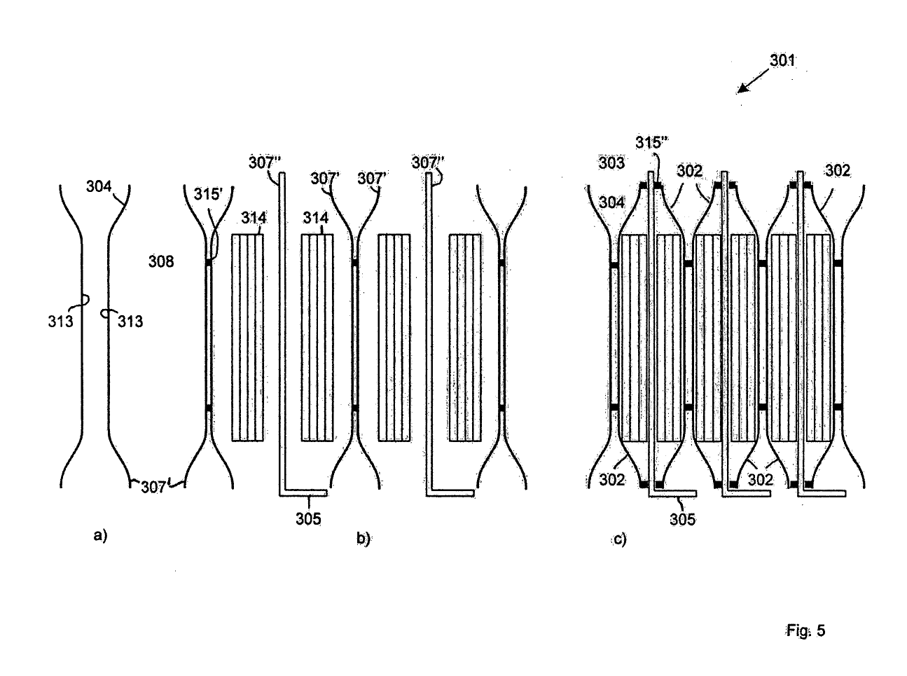

FIG. 5 is a diagrammatic cross section of a battery arrangement in a third embodiment during the individual manufacturing steps a) to c);

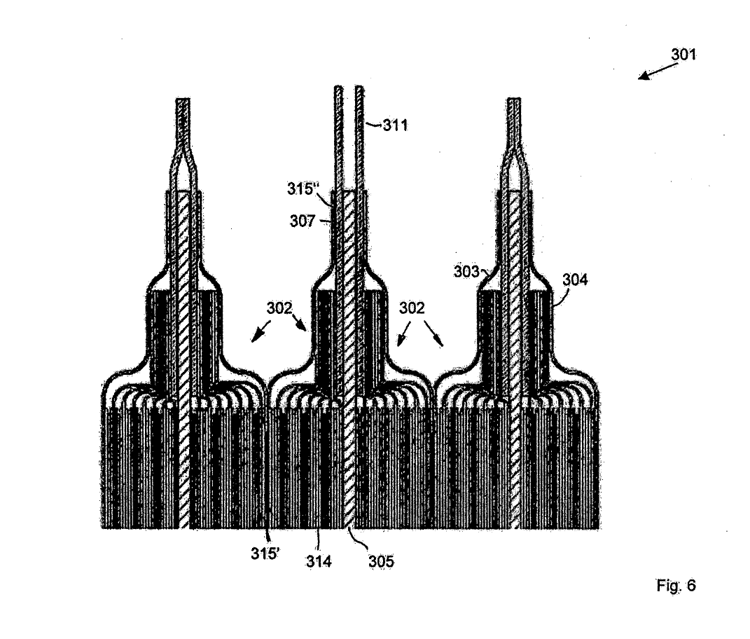

FIG. 6 is a partial cross section of the battery arrangement from FIG. 5;

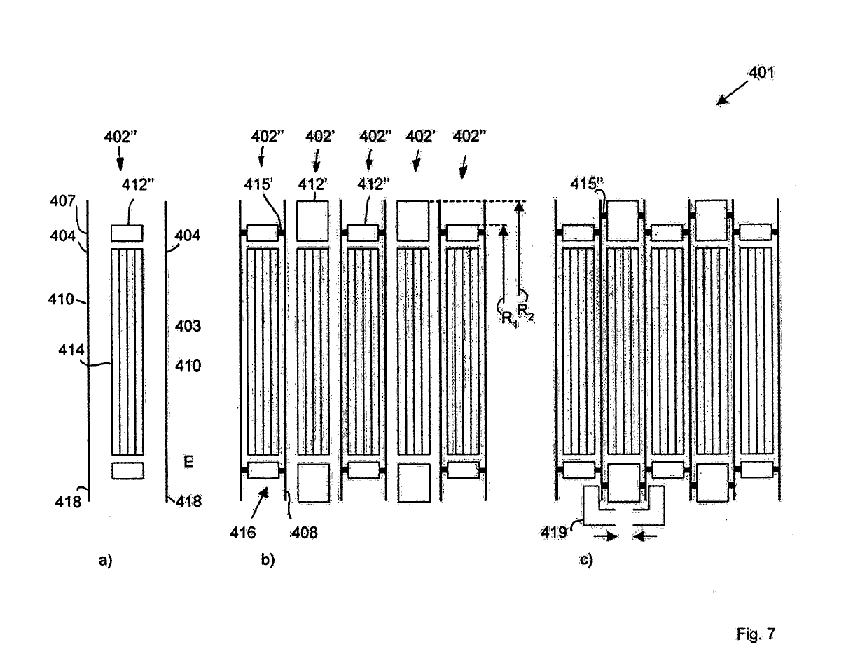

FIG. 7 is a diagrammatic cross section of a battery arrangement in a fourth embodiment during the individual manufacturing steps a) to c);

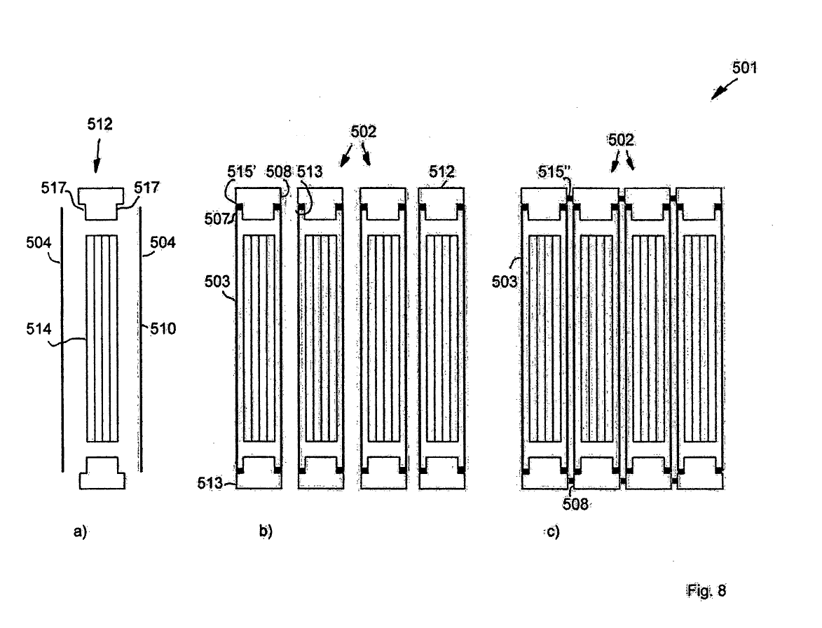

FIG. 8 is a diagrammatic cross section of a battery arrangement in a fifth embodiment during the individual manufacturing steps a) to c);

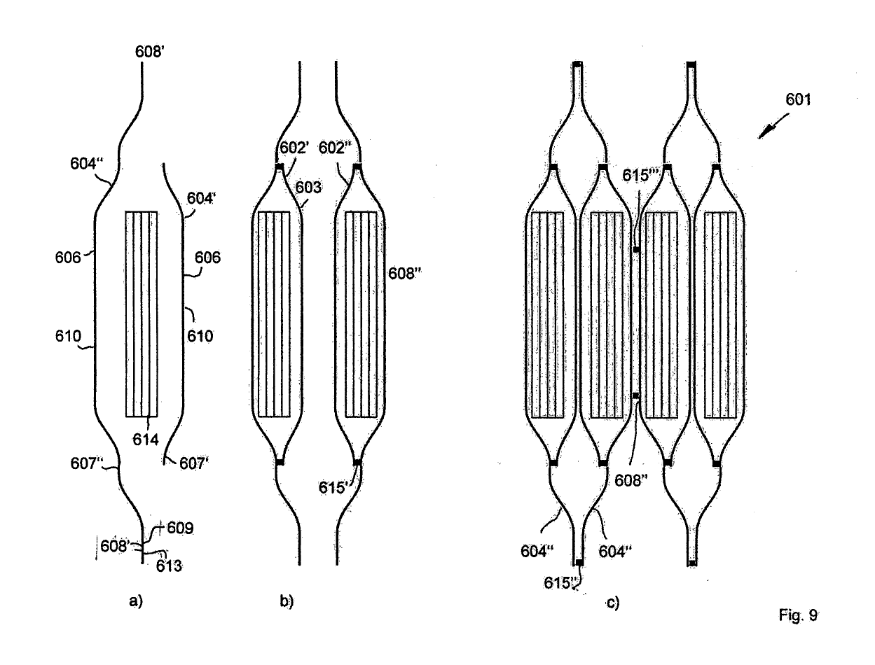

FIG. 9 is a diagrammatic cross section of a battery arrangement in a sixth embodiment during the individual manufacturing steps a) to c).

FIG. 1a) to 1d) describe how a battery arrangement 101 can be manufactured in a first embodiment. FIG. 1a) first reveals two molded parts 104′, 104″, which represent shell parts of shells 103′, 103″ of two electrochemical cells 102′, 102″. In this regard, the molded parts depicted on FIG. 1a) are to be allocated to these two different electrochemical cells 102′, 102″. The two molded parts are mirror-symmetric, but otherwise configured identically to each other. In this sense, details relating to the molded parts will always be described only once. Each of the molded parts exhibits a surface section 110, which is circumferentially adjoined radially outwardly by a seam section 107. The surface section 110 spans a plane E. The seam section 107 protrudes from plane E.

Molded parts 104′, 104″ are designed as laminated molded parts. The molded parts here exhibit an aluminum layer, both sides of which are provided with a layer of polypropylene. Polypropylene is a sealable material. As an alternative, polyamide can be used as a sealable material.

Arranged on the respective outer surfaces 106 of the molded parts 104 are bonding sections 108, which are located inside the surface section 110. As evident from FIG. 1b), the two molded parts 104′, 104″ are rigidly bonded with each other at the bonding sections 108 by means of a first circumferential bonded joint 115′. Bonding takes place on a respective bonding surface 113 on the bonding section 108 of the respective molded parts 104. The bonding surfaces 113 lie in plane E.

In the procedural stage depicted on FIG. 1b), the molded parts 104 of different electrochemical cells are now bonded with each other, without additional shell parts of the shells 103 of the respective electrochemical cells 102 being connected to the molded parts 104′, 104″. Therefore, the shells 103 are not yet closed. As may be gleaned from FIG. 1c, an electrode stack 114 is placed against an inner surface 109 of the molded parts 104′, 104″ in the next step. Another shell part, specifically molded part 104′″, is subsequently placed against the molded part 104′, or 104″″ against molded part 104″. The newly abutting molded parts 104′″ and 104″″ are in turn already rigidly bonded with additional molded parts of shells of additional electrochemical cells.

As may be gleaned from FIG. 1d), the molded parts 104′, 104′″ or 104″, 104″″ allocated to a respective electrochemical cell 102 and their shells 103 are then rigidly bonded with each other by means of a second circumferential bonded joint 115″ on the respective seam sections 107. The shells 103 of the respective electrochemical cells 102 are then sealed.

FIG. 2 shows a detailed partial cross sectional view of the electrochemical cell 101 according to the first embodiment. In addition to FIG. 1a) to 1d), all electrochemical cells 102 exhibit current conductors 111, which extend through the shell 103 at a specific location of the seam section 107. As further evident, the current conductors 111 are electrically connected with at least one part of the electrode stack 114.

FIG. 3 shows a further development of the battery arrangement from FIG. 1. In this regard, reference is made to the explanations for FIG. 1, and only the differences relative to FIG. 1 will be discussed. Shown herein is how a battery arrangement 201 can be manufactured in a second embodiment. Visible are two molded parts 204′, 204″, which are symmetrically designed relative to each other. The two molded parts 204 each represent shell parts of a joint shell 203 of a shared electrochemical cell 202. The molded parts 204 essentially correspond to molded parts 104 from FIG. 1. Therefore, only the differences will be touched upon below. As opposed to the molded parts 104 according to FIG. 1, the molded part 204 exhibits respective two separate bonding sections 208, which outwardly adjoin the seam sections 207 on two different sides of the molded part 204. Therefore, the bonding sections 208 are arranged on a side of the seam section 207 facing away from the surface section 210. The bonding section 208 here protrudes from the seam section 207 toward plane E. The bonding section 208 here exhibits a bonding surface 213 situated in plane E. In this regard, the bonding surface 213 and surface section 210 of a molded part 204 are aligned flush relative to each other.

As evident, an electrode stack 214 is made to abut an inner surface 209 of one of the molded parts 204′. The other of the two molded parts 204″ is then placed against the electrode stack 214, and made to abut the other molded part 204′. The two molded parts 204′, 204″ are rigidly bonded with each other on the seam section 207 by means of a first bonded joint 215′. This seals the shell 203 of the electrochemical cells 202. In another procedural step visible on FIG. 3c), two electrochemical cells 202′, 202″ both formed in the procedural step depicted on FIG. 3b) are placed against each other and rigidly bonded with each other by means of a second bonded joint 215″ with the respective bonding surfaces 213 of the bonding sections 208. Additional electrochemical cells are rigidly bonded with the existing electrochemical cells in the same way.

FIGS. 4a) and 4b) show sections of the battery arrangement 201 with the respective electrochemical cells 202. Visible on FIG. 4b) in particular is a honeycomb structure, which is formed by the bonding sections 208 and seam sections 207 of the shells 203 of the electrochemical cells 202 as well as the bonded joints 215.

FIG. 5 shows a further development of the battery arrangement from FIG. 1. In this regard, reference is made to the explanations for FIG. 1, and only the differences relative to FIG. 1 will be discussed. As evident from the depicted third embodiment of a battery arrangement 301, the two molded parts 304 bonded with each other are alternatively replaced by a heat conducting plate 305 arranged between two electrode stacks 314. The heat conducting plate 305 here itself represents a shell part of the shell 303 of an electrochemical cell 302. At seam sections 307′, the molded parts 304 are rigidly bonded with seam sections 307″ of the heat conducting plates 305 by means of a second bonded joint 315″. The heat conducting plate 305 represents a shell part used to partially envelop two adjacent electrochemical cells 302. The molded parts 304 have an identical configuration to the molded parts 104 of the battery arrangement from FIG. 1. Two adjacent molded parts 304 are bonded in the manner already explained in relation to FIG. 1. An electrode stack abuts both a molded part 304 and a heat conducting plate 305.

The third embodiment of the battery arrangement 301 may be gleaned from FIG. 6, and encompasses several electrochemical cells 302. Current conductors 311 of the outermost electrochemical cell 302 depicted are bonded with each other. In this regard, the electrode stacks 314 of these electrochemical cells are connected with each other in series. This arrangement is especially well suited for binary cells.

FIG. 7 shows a further development of the battery arrangement from FIG. 1. In this regard, reference is made to the explanations for FIG. 1, and only the differences relative to FIG. 1 will be discussed. In a fourth embodiment, the battery arrangement 401 encompasses several first electrochemical cells 402′ and several second electrochemical cells 402″, wherein the first and second electrochemical cells are arranged so as to alternate with each other. FIG. 7a) shows a second electrochemical cell 402″ prior to its installation. The second electrochemical cell 402″ exhibits a cell stack 414 arranged between two identical molded parts 404. The molded parts 404 have a flat configuration, wherein the surface section 410 is arranged in plane E along with the seam section 407. Further shown is a circumferential second frame 412″, which borders the cell stack 414. A first respective bonded joint 415′ is used to rigidly bond the two molded parts 404 allocated to a shared second electrochemical cell 402″ by means of their respective seam section 407 with the second frame 412″. As a result, the shell 403 of the second electrochemical cell 402″ is sealed.

Let it be noted that the molded parts 404 exhibit a circumferential overhang 418 that radially projects over the second frame 412″. This creates a radial recess 416 between the two molded parts 404.

Another cell stack 414 bordered by a first frame 412′ is placed between two second electrochemical cells 402″. The second frame 412′ is rigidly bonded by means of a respective second bonded joint 415″ with the molded parts 404 of the second electrochemical cell 402″ at their bonding section 408. Let it be noted that the first frame 412′ has a radial expansion R₁, which is larger than a radial expansion R₂ of the second frame 412″. In this regard, the first frame 412′ projects over the second frame 412″ in the circumferential direction, and extends into the radial area of the recess 416. A tool 419 used for the second bonded joint 415″ between the second frame and molded part 404 can engage into the recesses 416.

The molded part 404 forms a respective shell part for both enveloping one of the first electrochemical cells 402′ and enveloping one of the second electrochemical cells 402″. The first frames 412′ form shell parts of the respective first electrochemical cell 402. The second frames 412″ form shell parts of the respective second electrochemical cell 402″.

FIG. 8 shows a further development of the battery arrangement from FIG. 7. In this regard, reference is made to the explanations for FIG. 7, and only the differences relative to FIG. 7 will be discussed. In a fifth embodiment, the electrochemical cells 502 of the battery arrangement 501 each encompass a frame 512, which is circumferentially arranged around an electrode stack 514.

Each electrochemical cell 502 further encompasses two respective molded parts 504, which are essentially identical in design to the molded parts 404 of the preceding embodiment. Each face of the frames 512 exhibits a circumferential shoulder 517, on which the respective molded part 504 can be made to abut, and can be rigidly bonded with the molded parts 504 by means of a first bonded joint 515′. A second bonded joint 515″ is used to rigidly bond together the frames 512 of the individual electrochemical cells 502 on respective bonding surfaces 513 of bonding sections 508 arranged on the faces of the frames 512.

FIG. 9 shows a further development of the battery arrangement from FIG. 1. In this regard, reference is made to the explanations for FIG. 1, and only the differences relative to FIG. 1 will be discussed. In a sixth embodiment, the battery arrangement 601 encompasses several electrochemical cells 602, the shell 603 of which is formed by respective two molded parts 604′, 604″, which are not identical or mirror symmetric to each other in design. A first molded part 604′ is identically configured to the molded parts 104 according to FIG. 1. The basic structure of a second molded part 604″ is identical in design to the first molded part 204′ from FIG. 3. The seam section 607′ of the first molded part 604′ is rigidly bonded by means of a first bonded joint 615′ with the seam section 607″ of the second molded part 604″. This seals the electrochemical cell 602 and its shell 603. As opposed to the first molded part 204′ from FIG. 3, the bonding section 608′ protrudes from the seam section 607″ away from plane E. With the two molded parts bonded together, the second molded part 604″ here radially protrudes over the first molded part 604′. In an additional manufacturing step, the second molded part 604″ is placed against another second molded part 604″ of an adjacent electrochemical cell 602, and rigidly bonded with the latter by means of a second bonded joint 615″ at respective inner surfaces 609 on the bonding section 608. A third bonded joint 615″ is used to further rigidly bond the second molded part 604′″ with another second molded part 604″ of another electrochemical cell. The third bonded joint 604′″ is created on an additional bonding section 608′″ identical to the first bonded joint 115′ according to the first embodiment, as depicted on FIG. 1. In this regard, reference is made to the applicable explanations. The second molded parts 604″ here exhibit two bonding sections 608′, 608″, on which the two molded parts 604″ are bonded with molded parts of other electrochemical cells.

Should the first bonded joint 615′ that provides the shells 603 of the electrochemical cells 602 with a gas and liquid tight seal develop a leak, the second bonded joint 615″ prevents material from being exchanged between the environment and the interior of the electrochemical cell 602. In this regard, the electrochemical cell 602 exhibits a redundant, and thus improved, shell 603.

It holds true for all bonded joints described with respect to the exemplary embodiments that the bonded joint between the shell parts is formed by heat sealable layers of the shell parts. This adhesive bond is here fabricated by having the heat sealable layers of the shell parts come to abut each other, and then exposing them to heat. The heat exposure causes the heat sealable material to melt on the shell parts, thus allowing it to adhesively bond with the heat sealable material of the respective other shell part. The use of additional adhesives or sealants, i.e., aids, for manufacturing an adhesive bond that is not a constituent of the layers in the shell parts is not provided.

### REFERENCE LIST

101, 201, . . . Battery arrangement

102, 202, . . . Electrochemical cell

103, 203, . . . Shell

104, 204, . . . Molded part

305 Heat conducting plate

106, 206, . . . Outer surface

107, 207, . . . Seam section

108, 208, . . . Bonding section

109, 209, . . . Inner surface

110, 210, . . . Surface section

111, 211, . . . Current conductor

412, 512 Frame

113, 213, . . . Bonding surface

114, 214, . . . Electrode stack

115, 215, . . . Bonded joint

416 Recess

517 Shoulder

418 Overhang

419 Tool

E Plane

R Radial expansion

1.-34. (canceled)

35. A method for manufacturing a battery arrangement (101, 201, . . . ), comprising at least one first electrochemical cell (102, 202, . . . ) and at least one second electrochemical cell (102, 202, . . . ), wherein each electrochemical cell exhibits a shell (103, 203, . . . ),
wherein
a shell part (140, 105, 112; 204, 205, 212; . . . ) of the shell (103, 203, . . . ) of the first electrochemical cell (102, 202, . . . ) is adhesively bonded with a shell part (104, 105, 112;
204, 205, 212; . . . ) of the shell (103, 203, . . . ) of the second electrochemical cell (102, 202, . . . ),
wherein
at least one of the shell parts (104, 105, 112; 204, 205, 212; . . . ) is fabricated out of a laminated packing film, which exhibits a layer comprised of a sealable material, specifically a thermoplastic, wherein the layer consisting of a sealable material is used to manufacture the adhesive bond.

36. The method according to claim 35,
wherein
exclusively the layer consisting of sealable material of at least one shell part (104, 105, 112;
204, 205, 212; . . . ) is used to manufacture the adhesive bond between these shell parts (104, 105, 112; 204, 205, 212; . . . ).

37. The method according to claim 36,
wherein the adhesive bond is created via heat sealing, heat pressing or bonding, in particular heat bonding.

38. The method according to claim 37,
wherein
a bonding section (108, 208, . . . ) of the first electrochemical cell (102, 202, . . . ) is placed against a bonding section (108, 208, . . . ) of the second electrochemical cell (102, 202, . . . ), wherein the bonding section (108, 208, . . . ) is arranged on a shell part (104, 105, 112; 204, 205, 212; . . . ) of the respective electrochemical cell (102, 202, . . . ).

39. The method according to claim 38,
wherein
the shell (103, 203, . . . ) is fabricated by bonding a first shell part (104, 105, 112; 204, 205, 212; . . . ) with at least one second shell part (104, 105, 112; 204, 205, 212; . . . ).

40. The method according to claim 39,
wherein
the first shell part (104, 105, 112; 304, 305, 312; 404, 405, 412) of the first electrochemical cell (102, 302, 402) is bonded with one of the shell parts (104, 105, 112; 304, 305, 312; 404, 405, 412) of the second electrochemical cell (102, 302, 402) before the first shell part (104, 105, 112; 304, 305, 312; 404, 405, 412) of the first electrochemical cell (102, 302, 402) is bonded with a second shell part (104, 105, 112; 304, 305, 312; 404, 405, 412) of the first electrochemical cell (102, 302, 402).

41. The method according to claim 40,
wherein
after a shell part (104, 105, 112; 304, 305, 312; 404, 405, 412) of the first electrochemical cell (102, 302, 402) has been bonded with a shell part (104, 105, 112; 304, 305, 312; 404, 405, 412) of the second electrochemical cell (102, 302, 402), an electrode stack (109, 309, 409) is made to abut a shell part (104, 105, 112; 304, 305, 312; 404, 405, 412).

42. The method according to claim 41,
wherein
a shell part (304, 305, 312; 404, 405, 412), in particular a molded part (304, 404), is used as the shell part for at least partially enveloping two, in particular adjacent electrochemical cells (102, 302, 402).

43. The method according to claim 42,
wherein
at least one of the shell parts (104, 105, 112; 204, 205, 212; . . . ) is a molded part (104, 204,

44. The method according to claim 43,
wherein
at least one of the shell parts (104, 105, 112; 204, 205, 212; . . . ) is a heat conducting plate (305).

45. The method according to claim 44,
wherein
at least one of the shell parts (104, 105, 112; 204, 205, 212; . . . ) is a frame (412, 512) or a frame part.

46. An electrochemical cell (102, 202, . . . ), comprising at least one electrode stack (109, 209, . . . ), which is at least partially enveloped by a shell (103, 203, . . . ),
wherein the shell (103, 203, . . . ) encompasses at least one molded part (104, 204, . . . ) with a surface section (110, 210, . . . ) and a seam section (107, 207, . . . ),
wherein the seam section (107, 207, . . . ) is circumferentially arranged around the surface section (110, 210, . . . ),
wherein
a bonding section (108, 208, . . . ) is provided on the molded part (104, 204, . . . ) and at least one molded part (104, 204, . . . ) is fabricated out of a laminated packing film, which exhibits a layer comprised of a sealable material, specifically a thermoplastic.

47. The electrochemical cell (102, 202, . . . ) according to claim 46,
wherein
the molded part (104, 204, . . . ) is a laminated molded part.

48. The electrochemical cell (102, 202, . . . ) according to claim 47,
wherein
the seam section protrudes out of a plane E, in which the surface section (110, 210, 310, 610) is arranged.

49. The electrochemical cell (102, 202, . . . ) according to claim 48,
wherein
parts of the seam section (307) represent a bonding section (308).

50. The electrochemical cell (102, 202, . . . ) according to claim 49,
wherein
the bonding section (208, 408, 608) adjoins at least one part of the seam section (207, 407, 607).

51. The electrochemical cell (102, 202, . . . ) according to claim 50,
wherein
two bonding sections (208, 608) are provided, which in particular are situated arranged on opposing sides of the molded part (204, 604), in particular on opposing parts of the circumferential seam section (207, 607).

52. The electrochemical cell (102, 202, . . . ) according to claim 51,
wherein
at least one bonding section (208, 608) is arranged on a side of the seam section (207, 607) facing away from the surface section (210, 610).

53. The electrochemical cell (102, 202, . . . ) according to claim 52,
wherein
at least one bonding section (208) protrudes from the seam section (207) toward plane E.

54. The electrochemical cell (102, 202, . . . ) according to claim 53,
wherein
at least one bonding section (608) protrudes from the seam section (607) away from plane E.

55. The electrochemical cell (102, 202, . . . ) according to claim 54,
wherein
the bonding section (108, 208, 408) encompasses a bonding surface (113, 213, 413), which is arranged in particular parallel to plane E, in particular in the plane E.

56. The electrochemical cell (102, 202, . . . ) according to claim 55,
wherein
two molded parts (104, 204, . . . ) are bonded with each other at their seam section (107, 207, . . . ), in particular adhesively bonded with each other.

57. The electrochemical cell (102, 202, . . . ) according to claim 56,
wherein
the shell (303) encompasses at least one heat conducting plate (305), wherein at least one molded part (304) is flanged to the heat conducting plate (305) by way of a seam section (307).

58. A battery arrangement (101, 201, . . . ), comprising a first electrochemical cell (102, 202, . . . ) and a second electrochemical cell (102, 202, . . . ), wherein at least one shell part (103, 203, . . . ) of the first electrochemical cell is adhesively bonded with at least one shell part (103, 203, . . . ) of the second electrochemical cell,
wherein
at least one of the shell parts (103, 203, . . . ) is fabricated out of a laminated packing film, which exhibits a layer comprised of a sealable material , wherein the adhesive bond between the shell parts (104, 105, 112; 204, 205, 212; . . . ) is formed by at least portions of the layer comprised of sealable material.

59. A battery arrangement (101, 201, . . . ) according to claim 58,
wherein
the adhesive bond between at least two shell parts (103, 203, . . . ) is formed exclusively by the layers comprised of sealable material of one or more of the shell parts (103, 203, . . . ).

60. A battery arrangement (101, 201, . . . ) according to claim 58,
wherein
the first electrochemical cell (402, 502) encompasses an at least partially circumferential first frame (412′, 512′), in particular a completely circumferential first frame (412′, 512′), and that the second electrochemical cell (402, 502) encompasses an at least partially circumferential second frame (412″, 512″), in particular a completely circumferential second frame (412″, 512″), wherein the first frame (412′, 512′) is adhesively bonded with the second frame (412″, 512″).

61. A battery arrangement (101, 201, . . . ) according to claim 60,
wherein
the frames (412) of adjacent electrochemical cells (402) exhibit sections with varying different radial expansions.

62. A battery arrangement (101, 201, . . . ) according to claim 61,
wherein
the first frame (412′) of the first electrochemical cell (402′) exhibits a first radial expansion (R1), and the second frame (412″) of the second electrochemical cell (402″), which abuts the first electrochemical cell (402′), exhibits a second radial expansion (R2), wherein the first radial expansion (R1) is larger than the second radial expansion (R2).

63. A battery arrangement (101, 201, . . . ) according to claim 61, wherein at least one of the electrochemical cells is configured according to claim 57.

64. A battery arrangement (101, 201, . . . ) manufactured according to claim 35.

65. A battery arrangement (201) according to claim 64, wherein seam sections (207) of adjacent electrochemical cells (203) form a honeycomb bonding structure with bonding sections (208) of adjacent electrochemical cells (203).
